(19) United States
(12) Patent Application Publication
(10) Pub. No.: US 2026/0357761 A1
(43) Pub. Date: Nov. 12, 2026

(54) CONTROL DEVICE FOR INTERNAL COMBUSTION ENGINE

(71) Applicant: TOYOTA JIDOSHA KABUSHIKI KAISHA, Toyota-shi (JP)

(72) Inventors: Shingo KORENAGA, Nagoya-shi (JP); Koichi KITAURA, Ebina-shi (JP); Takahiko FUJIWARA, Sunto-gun (JP); Hiroshi KOBAYASHI, Numadu-shi (JP)

(73) Assignee: TOYOTA JIDOSHA KABUSHIKI KAISHA, Toyota-shi (JP)

(21) Appl. No.: 19/441,381

(22) Filed: Jan. 6, 2026

(30) Foreign Application Priority Data
Mar. 17, 2025 (JP) 2025-042213

(51) Int. Cl. F02D 41/12

(52) U.S. Cl. CPC F02D 41/126; F02D 2200/0814

(57) ABSTRACT

In a control device for an internal combustion engine, a control unit determines whether the amount of oxygen stored in a predetermined region on the upstream side of a three-way catalyst is smaller than a predetermined amount, in response to satisfaction of a fuel-cut condition. When it is determined that the amount of oxygen stored in the predetermined region is smaller than the predetermined amount, the control unit delays execution of fuel cut for a predetermined period and sets the engine air-fuel ratio to a lean air-fuel ratio during the predetermined period. When it is determined that the amount of oxygen stored in the predetermined region is greater than or equal to the predetermined amount, the control unit immediately executes fuel cut.

### CROSS-REFERENCE TO RELATED APPLICATION

This application claims priority to Japanese Patent Application No. 2025-042213 filed on Mar. 17, 2025. The disclosure of the above-identified application, including the specification, drawings, and claims, is incorporated by reference herein in its entirety.

### BACKGROUND

### 1. Technical Field

The present disclosure relates to control devices for internal combustion engines.

### 2. Description of Related Art

A technique is known in which fuel cut timing is delayed when the temperature of an exhaust control catalyst disposed in the exhaust passage of an internal combustion engine is high. In this technique, the engine air-fuel ratio is set to a lean air-fuel ratio during the delay period, and the length of the delay period is determined according to the amount of oxygen stored in the exhaust control catalyst (see, for example, Japanese Unexamined Patent Application Publication No. 2009-191665 (JP 2009-191665 A)).

### SUMMARY

An object of the present disclosure is to provide a technique that can suitably execute a fuel cut delay process.

One aspect of the present disclosure is a control device for an internal combustion engine in which a three-way catalyst having oxygen storage capacity is disposed in an exhaust passage. The control device may be configured to determine whether an amount of oxygen stored in a predetermined region on the upstream side of the three-way catalyst is smaller than a predetermined amount, in response to satisfaction of a fuel-cut condition of the internal combustion engine, delay execution of fuel cut of the internal combustion engine for a predetermined period and set an engine air-fuel ratio to a lean air-fuel ratio during the predetermined period, in response to a determination that the amount of oxygen stored in the predetermined region is smaller than the predetermined amount, and immediately execute the fuel cut of the internal combustion engine in response to a determination that the amount of oxygen stored in the predetermined region is greater than or equal to the predetermined amount.

The present disclosure can provide a technique that can suitably execute a fuel cut delay process.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of the configuration of a vehicle according to an embodiment;

FIG. 2 is a diagram schematically showing an example of changes over time in an oxygen storage region of a three-way catalyst in the embodiment;

FIG. 3A is a diagram illustrating a first threshold in the embodiment;

FIG. 3B is a diagram illustrating a second threshold in the embodiment;

FIG. 4 is a timing chart showing an example of changes over time in a rich flag, oxygen storage amount (OSA) of the three-way catalyst, temperature (bed temperature) of the three-way catalyst, degradation suppression flag, engine air-fuel ratio (A/F), fuel-cut (F/C) condition, and fuel cut (F/C);

FIG. 5 is a flowchart showing an example of a first processing routine executed by an electronic control unit (ECU) every cycle; and

FIG. 6 is a flowchart showing an example of a second processing routine executed by the ECU when the F/C condition is satisfied.

### DETAILED DESCRIPTION OF EMBODIMENTS

For an internal combustion engine in which a three-way catalyst having oxygen storage capacity is disposed in an exhaust passage, a technique has been proposed in which, when the temperature of the three-way catalyst is high at the time a fuel-cut condition is satisfied, fuel cut is delayed while operating the internal combustion engine at a lean air-fuel ratio. With this technique, oxygen can be gradually stored in the three-way catalyst before fuel cut is executed. This suppresses the occurrence of a rapid oxygen storage reaction upon execution of fuel cut, thereby suppressing thermal degradation of the three-way catalyst.

However, whether the three-way catalyst is prone to thermal degradation due to fuel cut depends on the amount of oxygen stored in a region on the upstream side of the three-way catalyst. Through extensive experiments and verification, the inventors have found that when the amount of oxygen stored in the region on the upstream side of the three-way catalyst is large, the three-way catalyst is less likely to undergo thermal degradation due to fuel cut, whereas when the amount of oxygen stored in that region is small, the three-way catalyst is more likely to undergo thermal degradation due to fuel cut. According to this finding, if fuel cut is delayed when a large amount of oxygen is stored in the region on the upstream side of the three-way catalyst, this may undesirably worsen the fuel consumption rate and/or emissions of the internal combustion engine.

Accordingly, in the control device for an internal combustion engine according to the present disclosure, the control unit determines, when a fuel-cut condition of the internal combustion engine is satisfied, whether the amount of oxygen stored in a predetermined region on the upstream side of the three-way catalyst is less than a predetermined amount. In one example, the predetermined region is located on the upstream side of the three-way catalyst in the exhaust flow direction and may account for about 40% of the entire three-way catalyst. For example, the predetermined amount may be set such that the three-way catalyst becomes more likely to undergo thermal degradation due to fuel cut when the amount of oxygen stored in the predetermined region falls below that amount.

When it is determined that the amount of oxygen stored in the predetermined region is less than the predetermined amount, the control unit delays execution of fuel cut of the internal combustion engine for a predetermined period. The control unit sets the engine air-fuel ratio to a lean air-fuel ratio during the predetermined period to gradually store oxygen in the three-way catalyst. On the other hand, when it is determined that the amount of oxygen stored in the predetermined region is greater than or equal to the predetermined amount, the control unit immediately executes fuel cut of the internal combustion engine. With such control, when it is determined that the amount of oxygen stored in the predetermined region on the upstream side of the three-way catalyst is greater than or equal to the predetermined amount, fuel cut is not delayed but is instead immediately executed, even if the temperature of the three-way catalyst is high. As a result, fuel cut is less likely to be delayed when the three-way catalyst is in a state where it is less likely to undergo thermal degradation. Accordingly, thermal degradation of the three-way catalyst can be suppressed while reducing deterioration in fuel consumption rate and emissions due to fuel cut delay.

### Embodiment

A specific embodiment of the present disclosure will now be described with reference to the drawings. Unless otherwise specified, the dimensions, materials, shapes, and relative arrangements of the components described in the embodiment are not intended to limit the technical scope of the disclosure to the illustrated examples alone.

### Overview of Vehicle

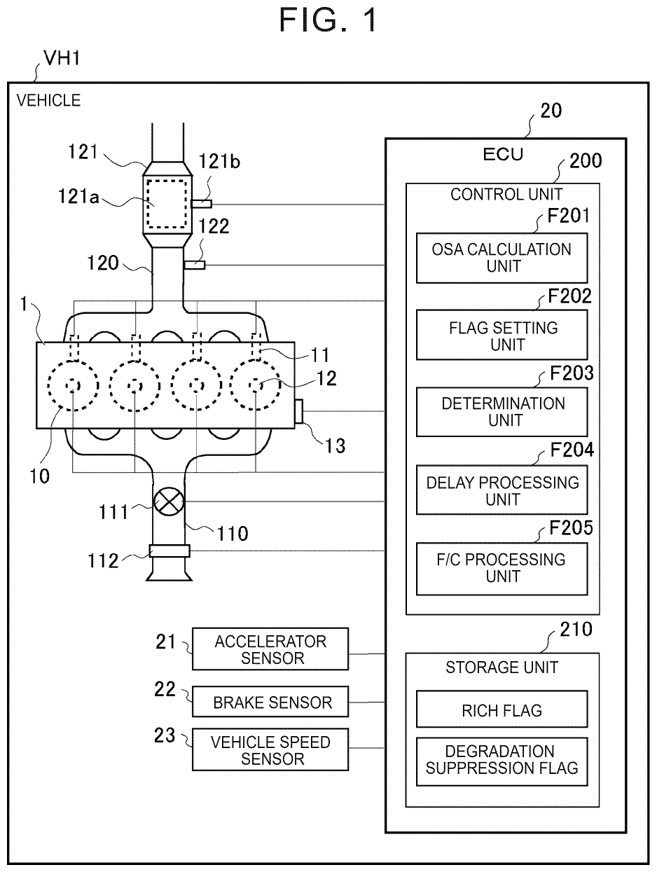

FIG. 1 shows an example of the configuration of a vehicle to which the present disclosure is applied. A vehicle VH1 illustrated in FIG. 1 is an internal combustion engine vehicle that uses an internal combustion engine 1 as a prime mover. The vehicle VH1 may be a hybrid electric vehicle (HEV) or a plug-in hybrid electric vehicle (PHEV) equipped with a hybrid system including the internal combustion engine 1. The internal combustion engine 1 is a four-stroke cycle spark-ignition engine using gasoline as fuel.

The internal combustion engine 1 is provided with a plurality of cylinders 10, a plurality of fuel injection valves 11 that inject fuel into the respective cylinders 10, a plurality of ignition plugs 12 that ignite an air-fuel mixture generated in the respective cylinders 10, and a crank position sensor 13 that detects a rotation angle of an output shaft (crankshaft).

An intake pipe 110 is connected to the internal combustion engine 1. The intake pipe 110 forms a passage through which air drawn into the internal combustion engine 1 flows. A throttle valve 111 and an airflow meter 112 are disposed along the intake pipe 110. The throttle valve 111 adjusts the intake air amount of the internal combustion engine 1, and the airflow meter 112 detects the intake air amount of the internal combustion engine 1. An exhaust pipe 120 is also connected to the internal combustion engine 1. The exhaust pipe 120 forms a passage through which gas produced by combustion within the cylinders of the internal combustion engine 1 (exhaust gas) flows. A catalyst casing 121 that houses a three-way catalyst 121a is disposed along the exhaust pipe 120. In the present embodiment, ceria is supported on the three-way catalyst 121a to provide oxygen storage capacity (OSC). A catalyst temperature sensor 121b is attached to the catalyst casing 121. The catalyst temperature sensor 121b detects the temperature (bed temperature) of the three-way catalyst 121a. The temperature of the three-way catalyst 121a may alternatively be obtained by using an exhaust temperature sensor disposed in the exhaust pipe 120 downstream of the catalyst casing 121. An air-fuel ratio sensor 122 is attached to the exhaust pipe 120 upstream of the catalyst casing 121. The air-fuel ratio sensor 122 detects the engine air-fuel ratio (i.e., the air-fuel ratio of the air-fuel mixture burned in the internal combustion engine 1) according to the oxygen concentration in the exhaust gas.

The vehicle VH1 of the present embodiment is equipped with an electronic control unit (ECU) 20 that controls operation of the internal combustion engine 1. The ECU 20 is an example of the “control device” according to the present disclosure, and can be configured as a computer that includes a processor (central processing unit (CPU), graphics processing unit (GPU), etc.), a main storage device (random access memory (RAM), read-only memory (ROM), etc.), and an auxiliary storage device (erasable programmable read-only memory (EPROM), hard disk drive, removable media, etc.). In the present embodiment, the ECU 20 includes a control unit 200 and a storage unit 210. The control unit 200 is a computation unit that implements various functions of the ECU 20 by executing predetermined programs stored in the auxiliary storage device. For example, the control unit 200 may be implemented by hardware such as a CPU. The control unit 200 may include RAM, ROM, cache memory, and the like. The functions implemented by the control unit 200 will be described later.

The storage unit 210 is a unit that stores various types of information, and includes RAM and an auxiliary storage device. The storage unit 210 stores programs executed by the control unit 200 and data used by those programs. The data stored in the storage unit 210 includes a rich flag and a degradation suppression flag, which will be described later.

A plurality of sensors that acquires sensor data used to control operation of the internal combustion engine 1 is connected to the ECU 20. The sensors connected to the ECU 20 include an accelerator sensor 21, a brake sensor 22, and a vehicle speed sensor 23, in addition to the crank position sensor 13, the airflow meter 112, the catalyst temperature sensor 121b, and the air-fuel ratio sensor 122. The accelerator sensor 21 detects an amount of operation of an accelerator pedal mounted on the vehicle VH1 (accelerator operation amount). The brake sensor 22 detects an amount of operation of a brake pedal mounted on the vehicle VH1. The vehicle speed sensor 23 detects the traveling speed of the vehicle VH1. The ECU 20 controls operation of the internal combustion engine 1 according to output signals from the above sensors.

### Software Configuration of Ecu

Next, the functions (software modules) implemented by the ECU 20 of the present embodiment will be described. In the present embodiment, as shown in FIG. 1, the control unit 200 of the ECU 20 includes a plurality of software modules such as an oxygen storage amount (OSA) calculation unit F201, a flag setting unit F202, a determination unit F203, a delay processing unit F204, and a fuel cut (F/C) processing unit F205. Each software module is implemented by the control unit 200 executing programs stored in the storage unit 210. At least part of these software modules may alternatively be implemented by hardware circuits such as application-specific integrated circuits (ASICs) or field-programmable gate arrays (FPGAs). In the following description, information processing executed by each of the OSA calculation unit F201, the flag setting unit F202, the determination unit F203, the delay processing unit F204, and the F/C processing unit F205 is equivalent to information processing executed by the control unit 200.

The OSA calculation unit F201 calculates the amount of oxygen currently stored in the three-way catalyst 121a (hereinafter referred to as “oxygen storage amount (OSA)”). The OSA may be calculated using known logic. For example, the calculation may be performed by integrating the balance between the amount of oxygen released from the three-way catalyst 121a during rich operation of the internal combustion engine 1 (engine air-fuel ratio=rich air-fuel ratio) and the amount of oxygen stored in the three-way catalyst 121a during lean operation of the internal combustion engine 1 (engine air-fuel ratio=lean air-fuel ratio). The amount of oxygen released from the three-way catalyst 121a and the amount of oxygen stored in the three-way catalyst 121a can be calculated based on the amount of exhaust gas flowing into the three-way catalyst 121a (i.e., the sum of the intake air amount and the fuel injection amount) and the engine air-fuel ratio. Such OSA calculation is repeatedly executed at predetermined intervals (for example, once per cycle) during operation of the internal combustion engine 1. Every time the OSA calculation unit F201 calculates the OSA, it passes the calculation result (the latest OSA) to the flag setting unit F202 described later.

The flag setting unit F202 switches a degradation suppression flag between ON and OFF. In the present embodiment, the degradation suppression flag is turned ON when the three-way catalyst 121a is in a predetermined state, and is turned OFF when the three-way catalyst 121a is not in the predetermined state. The predetermined state refers to a state in which the three-way catalyst 121a is likely to undergo thermal degradation when fuel cut (F/C) of the internal combustion engine 1 is executed while the three-way catalyst 121a is in that state. In the present embodiment, the predetermined state is a state in which the OSA is less than a threshold and the bed temperature of the three-way catalyst 121a is at or above a predetermined temperature (for example, about 700 °C). The threshold is a value used as an index for determining whether the amount of oxygen stored in a predetermined region on the upstream side of the three-way catalyst 121a is less than a predetermined amount. This threshold differs depending on the value of a rich flag.

In the internal combustion engine 1 of the present embodiment, when the rich flag is ON, the fuel injection amount is controlled through feedback control such that the engine air-fuel ratio detected by the air-fuel ratio sensor 122 becomes a predetermined rich air-fuel ratio A/F1. When the rich flag is OFF, the fuel injection amount is controlled through feedback control such that the engine air-fuel ratio detected by the air-fuel ratio sensor 122 becomes a predetermined lean air-fuel ratio A/F2. The rich flag is a storage area set in the storage unit 210. The rich flag is turned ON during a period in which the OSA decreases from the maximum amount (oxygen storage ratio=100%) to the minimum amount (oxygen storage ratio=0%), and is turned OFF during a period in which the OSA increases from the minimum amount to the maximum amount.

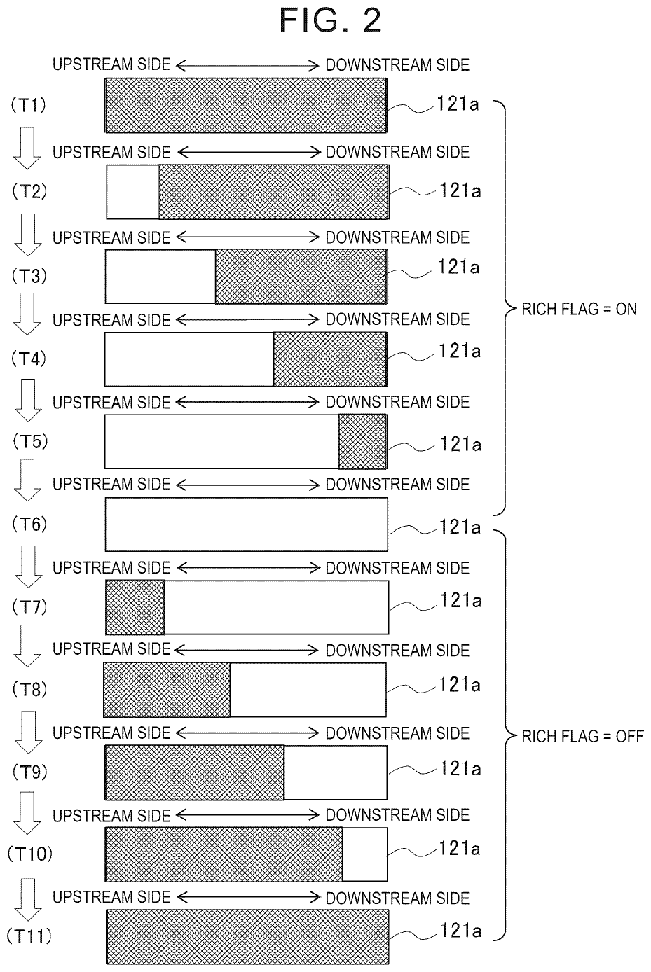

When feedback control of the fuel injection amount is performed as described above, the region of the three-way catalyst 121a in which oxygen is stored (hereinafter also referred to as the “oxygen storage region”) can differ depending on whether the rich flag is ON or OFF, even when the OSA is the same. FIG. 2 schematically illustrates an example of changes over time in the oxygen storage region of the three-way catalyst 121a. In the example shown in FIG. 2, time passes from T1 to T11. In FIG. 2, the white portions indicate regions where oxygen is not stored (regions from which oxygen has already been released), while the shaded portions indicate regions where oxygen is stored. In each of the pairs T2 and T10, T3 and T9, T4 and T8, and T5 and T7 in FIG. 2, the OSA values are equal to each other.

At time T1 in FIG. 2, the OSA has increased to the maximum amount (oxygen storage ratio=100%), and therefore the rich flag is turned ON. Accordingly, the engine air-fuel ratio is controlled to the predetermined rich air-fuel ratio A/F1. In this case, oxygen is released from the three-way catalyst 121a, resulting in a stoichiometric atmosphere in the three-way catalyst 121a and suitable control of the exhaust gas. As a result, the OSA gradually decreases over time from T1 to T6 in FIG. 2. During this oxygen release process, oxygen is sequentially released from the region on the upstream side of the three-way catalyst 121a toward the region on the downstream side thereof. When the OSA decreases to the minimum amount (oxygen storage ratio=0%) as shown at T6 in FIG. 2, the rich flag is switched from ON to OFF, and accordingly, the engine air-fuel ratio is switched from the predetermined rich air-fuel ratio A/F1 to the predetermined lean air-fuel ratio A/F2. In this case, oxygen in the exhaust gas is stored in the three-way catalyst 121a, resulting in a stoichiometric atmosphere in the three-way catalyst 121a and suitable control of the exhaust gas. As a result, the OSA gradually increases over time from T6 to T11 in FIG. 2. During this oxygen storage process, oxygen is sequentially stored from the region on the upstream side of the three-way catalyst 121a toward the region on the downstream side thereof. When the OSA increases to the maximum amount (oxygen storage ratio=100%) as shown at T11 in FIG. 2, the rich flag is switched from OFF to ON, and accordingly, the engine air-fuel ratio is controlled to the rich air-fuel ratio. Thereafter, the same transition as that from T1 to T11 is repeated.

As shown in FIG. 2, even when the OSA is the same, the oxygen storage region in the three-way catalyst 121a may differ depending on whether the rich flag is ON or OFF. For example, as seen from T5 and T7 in FIG. 2, the oxygen storage region is located near the downstream end of the three-way catalyst 121a at T5, whereas it is located near the upstream end of the three-way catalyst 121a at T7.

According to the inventors' findings, the three-way catalyst 121a is more likely to undergo thermal degradation due to fuel cut (F/C) when the amount of oxygen stored in a predetermined region on the upstream side of the three-way catalyst 121a is less than a predetermined amount, than when the amount of oxygen stored in the predetermined region is greater than or equal to the predetermined amount. In one example, the predetermined region is a region located on the upstream side of the three-way catalyst 121a in the exhaust flow direction and may account for about 10% to about 40% of the entire three-way catalyst 121a. However, the range of the predetermined region is not limited to 10% to 40%, and may vary depending on factors such as the size, shape, and composition of the three-way catalyst 121a. The predetermined amount is set such that thermal degradation of the three-way catalyst 121a due to fuel cut (F/C) is expected to become noticeable when the amount of oxygen stored in the predetermined region falls below that amount.

When determination as to whether the amount of oxygen stored in the predetermined region is less than the predetermined amount is made using the OSA, the threshold is set while taking into account the tendency shown in FIG. 2. That is, when the rich flag is OFF, the amount of oxygen stored in the predetermined region tends to be relatively large even when the OSA is relatively small. In contrast, when the rich flag is ON, the amount of oxygen stored in the predetermined region also tends to be relatively small when the OSA is relatively small. Accordingly, when the rich flag is OFF, thermal degradation of the three-way catalyst 121a due to fuel cut (F/C) is unlikely to occur even when the OSA is relatively small. However, when the rich flag is ON, thermal degradation of the three-way catalyst 121a due to fuel cut (F/C) is likely to occur unless the OSA is relatively large.

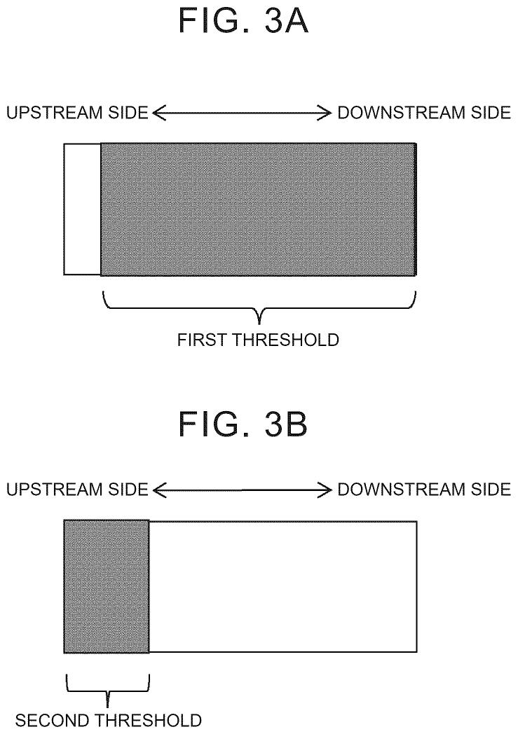

Accordingly, in the present embodiment, as shown in FIGS. 3A and 3B, the threshold used to determine whether the amount of oxygen stored in the predetermined region of the three-way catalyst 121a is less than the predetermined amount is set such that the threshold for the case where the rich flag is ON (the first threshold in FIG. 3A) is higher than the threshold for the case where the rich flag is OFF (the second threshold in FIG. 3B). For example, the first threshold may be set to an OSA corresponding to an oxygen storage ratio of 80% to 90% (more suitably 100%), while the second threshold may be set to an OSA corresponding to an oxygen storage ratio of 40%.

The following describes the flag setting unit F202 in more detail. In the present embodiment, when the rich flag is ON, the flag setting unit F202 determines that the three-way catalyst 121a is in a predetermined state when the OSA is smaller than the first threshold (that is, the amount of oxygen stored in the predetermined region is less than the predetermined amount) and the bed temperature of the three-way catalyst 121a is higher than or equal to a predetermined temperature. When the rich flag is OFF, the flag setting unit F202 determines that the three-way catalyst 121a is in the predetermined state when the OSA is smaller than the second threshold (that is, the amount of oxygen stored in the predetermined region is less than the predetermined amount) and the bed temperature of the three-way catalyst 121a is higher than or equal to the predetermined temperature.

Whether the three-way catalyst 121a is in the predetermined state is determined every time the OSA is calculated by the OSA calculation unit F201. Specifically, when the OSA is calculated by the OSA calculation unit F201, the flag setting unit F202 acquires the output signal of the catalyst temperature sensor 121b (i.e., the bed temperature of the three-way catalyst 121a) and the value of the rich flag. When the rich flag is ON, the flag setting unit F202 determines whether the OSA calculated by the OSA calculation unit F201 is smaller than the first threshold and the bed temperature detected by the catalyst temperature sensor 121b is higher than or equal to the predetermined temperature. When the OSA is smaller than the first threshold and the bed temperature is higher than or equal to the predetermined temperature, the flag setting unit F202 determines that the three-way catalyst 121a is in the predetermined state. In this case, the flag setting unit F202 turns the degradation suppression flag ON. On the other hand, when the OSA is greater than or equal to the first threshold and/or the bed temperature is lower than the predetermined temperature, the flag setting unit F202 determines that the three-way catalyst 121a is not in the predetermined state. In this case, the flag setting unit F202 turns the degradation suppression flag OFF.

When the rich flag is OFF, the flag setting unit F202 determines whether the

OSA calculated by the OSA calculation unit F201 is smaller than the second threshold and the bed temperature detected by the catalyst temperature sensor 121b is higher than or equal to the predetermined temperature. When the OSA is smaller than the second threshold and the bed temperature is higher than or equal to the predetermined temperature, the flag setting unit F202 determines that the three-way catalyst 121a is in the predetermined state. In this case, the flag setting unit F202 turns the degradation suppression flag ON. On the other hand, when the OSA is greater than or equal to the second threshold and/or the bed temperature is lower than the predetermined temperature, the flag setting unit F202 determines that the three-way catalyst 121a is not in the predetermined state. In this case, the flag setting unit F202 turns the degradation suppression flag OFF.

The determination unit F203 determines whether a fuel-cut delay condition is satisfied when a fuel-cut condition (F/C condition) is satisfied. The F/C condition may include, for example, that the engine speed calculated based on an output signal from the crank position sensor 13 is higher than or equal to a predetermined rotational speed, that the accelerator operation amount detected by the accelerator sensor 21 indicates a fully closed position, and that the traveling speed detected by the vehicle speed sensor 23 is higher than or equal to a predetermined speed. In the present embodiment, the fuel-cut delay condition includes that the three-way catalyst 121a is in the predetermined state. In the present embodiment, when the three-way catalyst 121a is in the predetermined state, the flag setting unit F202 turns the degradation suppression flag ON. When the three-way catalyst 121a is not in the predetermined state, the flag setting unit F202 turns the degradation suppression flag OFF. Accordingly, in the present embodiment, when the F/C condition is satisfied, the determination unit F203 may simply determine whether the degradation suppression flag is ON or OFF. When the degradation suppression flag is ON, the determination unit F203 determines that the fuel-cut delay condition is satisfied. When the degradation suppression flag is OFF, the determination unit F203 determines that the fuel-cut delay condition is not satisfied.

The delay processing unit F204 executes an F/C delay process when the determination unit F203 determines that the fuel-cut delay condition is satisfied. In the present embodiment, the F/C delay process is a process that delays execution of fuel cut (F/C) for a predetermined period (the period until the OSA of the three-way catalyst 121a becomes greater than or equal to the first threshold or the second threshold) after the F/C condition is satisfied. During the predetermined period (the fuel-cut delay period), the delay processing unit F204 sets the engine air-fuel ratio to an air-fuel ratio that is leaner than the stoichiometric air-fuel ratio and within the exhaust control window of the three-way catalyst 121a. For example, the engine air-fuel ratio during the predetermined period may be the same as, or slightly higher than (i.e., leaner than), the target air-fuel ratio (the predetermined lean air-fuel ratio A/F2) used for feedback control of the fuel injection amount when the rich flag is OFF.

When the OSA calculated by the OSA calculation unit F201 becomes greater than or equal to the first threshold or the second threshold as a result of execution of the F/C delay process by the delay processing unit F204, and the degradation suppression flag is accordingly switched from ON to OFF by the flag setting unit F202, the F/C delay process ends.

The F/C processing unit F205 executes fuel cut (F/C) of the internal combustion engine 1 when the determination unit F203 determines that the fuel-cut delay condition is not satisfied, and when the F/C delay process executed by the delay processing unit F204 is completed. For example, the F/C processing unit F205 may stop fuel injection by the fuel injection valve(s) 11 and stop ignition by the spark plug(s) 12.

### Timing Chart

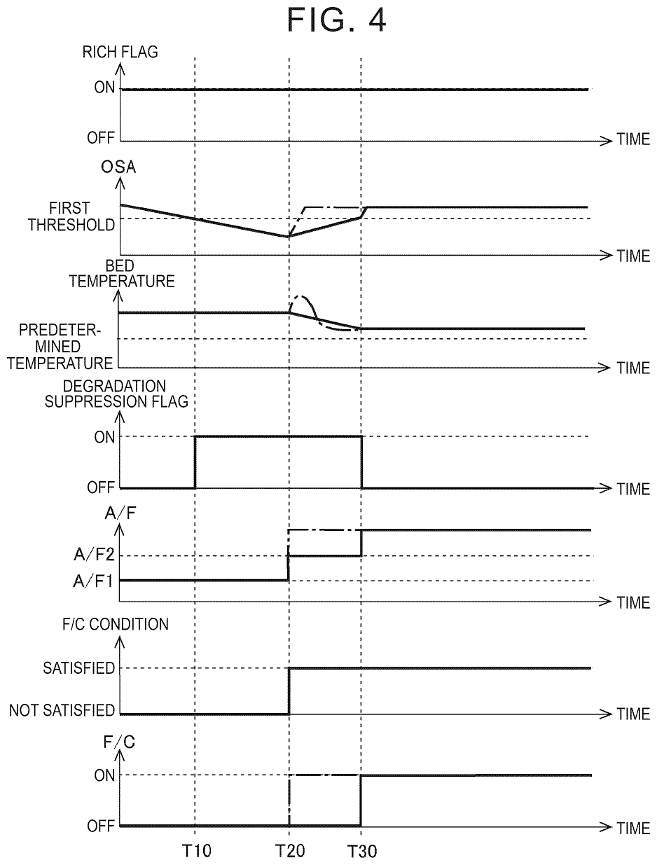

FIG. 4 is a timing chart showing an example of transitions of the rich flag, OSA, temperature (bed temperature) of the three-way catalyst 121a, degradation suppression flag, engine air-fuel ratio (A/F), fuel-cut (F/C) condition, and fuel cut (F/C). Transitions when the rich flag is ON are shown in FIG. 4. In each of the transitions of the OSA, temperature (bed temperature) of the three-way catalyst 121a, engine air-fuel ratio (A/F), and fuel cut (F/C) in FIG. 4, the long dashed short dashed line indicates a transition that occurs when fuel cut (F/C) is executed immediately after the F/C condition is satisfied.

As shown in FIG. 4, when the rich flag is ON, the fuel injection amount is controlled through feedback control such that the engine air-fuel ratio (A/F) becomes the predetermined rich air-fuel ratio A/F1. As a result, the OSA of the three-way catalyst 121a gradually decreases over time. When the OSA of the three-way catalyst 121a decreases below the first threshold (time T10 in FIG. 4), the OSA calculated by the OSA calculation unit F201 also becomes smaller than the first threshold. When such an OSA is calculated by the OSA calculation unit F201, the flag setting unit F202 acquires the bed temperature of the three-way catalyst 121a through the catalyst temperature sensor 121b and determines whether the acquired bed temperature is higher than or equal to the predetermined temperature. In the example shown in FIG. 4, since the bed temperature at time T10 is higher than the predetermined temperature, the flag setting unit F202 determines that the three-way catalyst 121a is in the predetermined state and switches the degradation suppression flag from OFF to ON. Subsequently, when the F/C condition is satisfied while the degradation suppression flag is ON (that is, when the OSA of the three-way catalyst 121a is smaller than the first threshold and the bed temperature is higher than or equal to the predetermined temperature) (time T20 in FIG. 4), the delay processing unit F204 executes the F/C delay process. As a result, the engine air-fuel ratio (A/F) after time T10 becomes lower (that is, less lean) than the air-fuel ratio when fuel cut (F/C) is executed.

When the F/C delay process is executed, the OSA of the three-way catalyst 121a increases more gradually than the OSA in the case where fuel cut (F/C) is executed. This suppresses the occurrence of a rapid oxygen storage reaction in the three-way catalyst 121a. As a result, the bed temperature of the three-way catalyst 121a changes at a lower level than when fuel cut (F/C) is executed immediately. Therefore, thermal degradation of the three-way catalyst 121a is suppressed. Subsequently, when the OSA of the three-way catalyst 121a increases to or above the first threshold as a result of the execution of the F/C delay process (time T30 in FIG. 4), the OSA calculated by the OSA calculation unit F201 also becomes higher than or equal to the first threshold. Accordingly, the flag setting unit F202 switches the degradation suppression flag from ON to OFF. When the degradation suppression flag is switched from ON to OFF, the delay processing unit F204 ends the F/C delay process, and the F/C processing unit F205 executes fuel cut (F/C).

When the rich flag is OFF, the fuel injection amount is controlled through feedback control such that the engine air-fuel ratio (A/F) becomes the predetermined lean air-fuel ratio A/F2. Accordingly, the OSA of the three-way catalyst 121a gradually decreases over time. During the process in which the OSA of the three-way catalyst 121a increases, the degradation suppression flag may be turned ON while the OSA is smaller than the second threshold. The engine air-fuel ratio (A/F) during the F/C delay process may be set to the same air-fuel ratio as that before execution of the F/C delay process (i.e., the predetermined lean air-fuel ratio A/F2).

### Operation of ECU

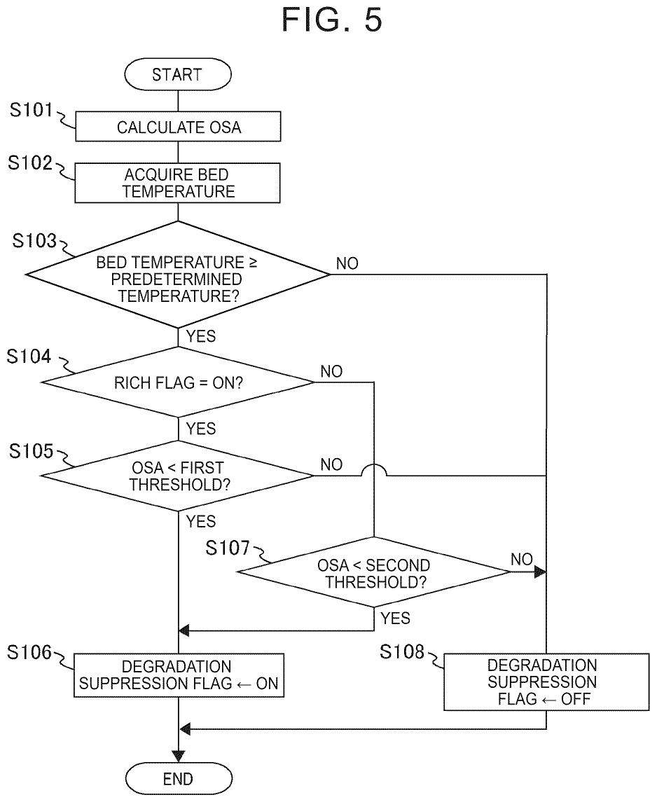

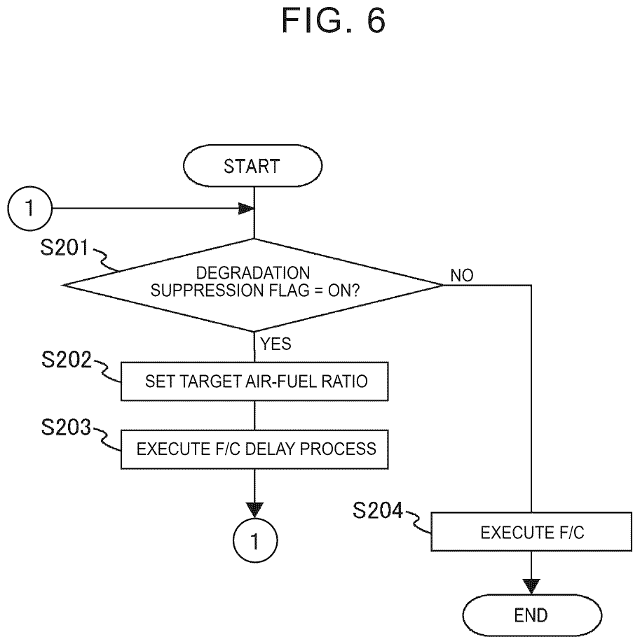

Next, the operation of the ECU 20 in the present embodiment will be described with reference to FIGS. 5 and 6. FIG. 5 is a flowchart showing an example of a first processing routine executed by the ECU 20 every cycle. FIG. 6 is a flowchart showing an example of a second processing routine executed by the ECU 20 when the F/C condition is satisfied. Although the main entity that executes the first and second processing routines is the control unit 200 (processor) of the ECU 20, the following description explains the operations using the software modules of the ECU 20 as the entities that execute these processing routines.

First, in the first processing routine shown in FIG. 5, the OSA calculation unit F201 of the ECU 20 calculates the current OSA of the three-way catalyst 121a (step S101). For example, the OSA calculation unit F201 may calculate the amount of oxygen stored in, or the amount of oxygen released from, the three-way catalyst 121a in the current cycle based on the intake air amount, fuel injection amount, and engine air-fuel ratio for that cycle, and add or subtract the calculated value to or from the previously calculated OSA (i.e., the OSA calculated in the immediately preceding cycle). More specifically, when the rich flag is OFF, the OSA calculation unit F201 may calculate the amount of excess oxygen contained in the exhaust gas based on the intake air amount and fuel injection amount, and add the calculated oxygen amount to the previously calculated OSA (i.e., the OSA calculated in the immediately preceding cycle). When the rich flag is ON, the OSA calculation unit F201 may calculate the amount of oxygen deficiency in the exhaust gas based on the intake air amount and fuel injection amount, and subtract the calculated deficiency from the previously calculated OSA. After the OSA calculation unit F201 completes step S101, the flag setting unit F202 executes step S102.

In step S102, the flag setting unit F202 acquires the bed temperature of the three-way catalyst 121a through the catalyst temperature sensor 121b. After completing step S102, the flag setting unit F202 executes step S103.

In step S103, the flag setting unit F202 determines whether the bed temperature acquired in step S102 is higher than or equal to a predetermined temperature. When the bed temperature of the three-way catalyst 121a is higher than or equal to the predetermined temperature (yes in step S103), the flag setting unit F202 executes step S104.

In step S104, the flag setting unit F202 accesses the storage unit 210 and determines whether the rich flag is ON. When the rich flag stored in the storage unit 210 is ON (yes in step S104), the flag setting unit F202 executes step S105.

In step S105, the flag setting unit F202 determines whether the OSA calculated by the OSA calculation unit F201 in step S101 is smaller than the first threshold (for example, an OSA corresponding to an oxygen storage ratio of 80% to 90%). When the OSA calculated by the OSA calculation unit F201 in step S101 is smaller than the first threshold (yes in step S105), the flag setting unit F202 proceeds to step S106 and sets the degradation suppression flag to ON. On the other hand, when the OSA calculated by the OSA calculation unit F201 in step S101 is greater than or equal to the first threshold (no in step S105), the flag setting unit F202 proceeds to step S108 and sets the degradation suppression flag to OFF.

When it is determined in step S104 that the rich flag is OFF (no in step S104), the flag setting unit F202 executes step S107. In step S107, the flag setting unit F202 determines whether the OSA calculated by the OSA calculation unit F201 in step S101 is smaller than the second threshold (for example, an OSA corresponding to an oxygen storage ratio of 40%). When the OSA calculated by the OSA calculation unit F201 in step S101 is smaller than the second threshold (yes in step S107), the flag setting unit F202 proceeds to step S106 and sets the degradation suppression flag to ON. On the other hand, when the OSA calculated by the OSA calculation unit F201 in step S101 is greater than or equal to the second threshold (no in step S107), the flag setting unit F202 proceeds to step S108 and sets the degradation suppression flag to OFF.

When it is determined in step S103 that the bed temperature is lower than the predetermined temperature (no in step S103), the flag setting unit F202 proceeds to step S108 and sets the degradation suppression flag to OFF.

After the flag setting unit F202 completes step S106 or step S108, the first processing routine ends.

Next, in the second processing routine shown in FIG. 6, the determination unit F203 of the ECU 20 determines whether the fuel-cut delay condition is satisfied (step S201). Specifically, the determination unit F203 determines whether the degradation suppression flag, which is set separately in the first processing routine of FIG. 5, is ON. When the degradation suppression flag is ON, the determination unit F203 determines that the fuel-cut delay condition is satisfied (yes in step S201). In this case, the control unit 200 of the ECU 20 operates as the delay processing unit F204 and executes the F/C delay process (steps S202 and S203).

In step S202, the delay processing unit F204 sets a target value (target air-fuel ratio) for the engine air-fuel ratio during execution of the F/C delay process. For example, as described above, the target air-fuel ratio may be the same as the predetermined lean air-fuel ratio A/F2. The target air-fuel ratio may be set to a leaner air-fuel ratio as the current OSA increases and/or as the current bed temperature decreases. However, in such a case, the target air-fuel ratio may be limited within the exhaust control window of the three-way catalyst 121a. After the F/C delay process completes step S202, the control unit 200 of the ECU 20 operates as the F/C processing unit F205 and executes step S203.

In step S203, the delay processing unit F204 executes the F/C delay process. Specifically, the delay processing unit F204 determines the fuel injection amount such that the engine air-fuel ratio in the next cycle becomes equal to the target air-fuel ratio set in step S202, and controls the fuel injection valve(s) 11 according to the determined fuel injection amount. The delay processing unit F204 also controls the spark plug(s) 12 such that ignition of the air-fuel mixture is performed in the next cycle. Although the ignition timing is not particularly limited, the ignition timing may be set such that the engine output becomes as small as possible. After the delay processing unit F204 completes step S203, the control unit 200 of the ECU 20 executes step S201 again.

When it is determined in step S201 that the fuel-cut delay condition is not satisfied (no in step S201), the control unit 200 of the ECU 20 operates as the F/C processing unit F205 and executes step S204. In step S204, the F/C processing unit F205 executes fuel cut (F/C) of the internal combustion engine 1. Specifically, the F/C processing unit F205 controls the fuel injection valve(s) 11 and the spark plug(s) 12 so as to stop fuel injection and ignition in the next cycle. Fuel cut (F/C) is continued until the F/C condition is no longer satisfied. After the F/C processing unit F205 completes step S204, the control unit 200 of the ECU 20 ends the second processing routine shown in FIG. 6.

### Functions and Effects of Embodiment

In the vehicle VH1 according to the present embodiment, the following operation is performed when the F/C condition is satisfied. When it is determined that the amount of oxygen stored in a predetermined region of the three-way catalyst 121a is smaller than a predetermined amount, the F/C delay processing is executed. When it is determined that the amount of oxygen stored in the predetermined region of the three-way catalyst 121a is greater than or equal to the predetermined amount, the F/C delay process is not executed, and fuel cut (F/C) is immediately executed. Accordingly, situations are less likely to occur in which the F/C delay process is executed when the three-way catalyst 121a is unlikely to undergo thermal degradation, or fuel cut (F/C) is executed when the three-way catalyst 121a is likely to undergo thermal degradation.

In the present embodiment, thermal degradation of the three-way catalyst 121a due to fuel cut (F/C) can be suppressed while minimizing deterioration in fuel consumption rate and emissions caused by the F/C delay process.

### Others

The above embodiment illustrates two conditions as the fuel-cut delay condition: that the OSA of the three-way catalyst 121a is smaller than the first threshold or the second threshold, and that the temperature (bed temperature) of the three-way catalyst 121a is higher than or equal to a predetermined temperature. However, one of these conditions, namely the condition that the OSA of the three-way catalyst 121a is smaller than the first threshold or the second threshold, may be used as the fuel-cut delay condition.

What is claimed is:

1. A control device for an internal combustion engine in which a three-way catalyst having oxygen storage capacity is disposed in an exhaust passage, the control device comprising a control unit configured to
determine whether an amount of oxygen stored in a predetermined region on an upstream side of the three-way catalyst is smaller than a predetermined amount, in response to satisfaction of a fuel-cut condition of the internal combustion engine,
delay execution of fuel cut of the internal combustion engine for a predetermined period and set an engine air-fuel ratio to a lean air-fuel ratio during the predetermined period, in response to a determination that the amount of oxygen stored in the predetermined region is smaller than the predetermined amount, and
immediately execute the fuel cut of the internal combustion engine in response to a determination that the amount of oxygen stored in the predetermined region is greater than or equal to the predetermined amount.

2. The control device according to claim 1, wherein
determining whether the amount of oxygen stored in the predetermined region is smaller than the predetermined amount includes
determining whether an oxygen storage amount of the three-way catalyst is smaller than a first threshold, in response to the engine air-fuel ratio immediately before satisfaction of the fuel-cut condition being set to a rich air-fuel ratio,
determining that the amount of oxygen stored in the predetermined region is smaller than the predetermined amount, in response to a determination that the oxygen storage amount of the three-way catalyst is smaller than the first threshold, and
determining that the amount of oxygen stored in the predetermined region is greater than or equal to the predetermined amount, in response to a determination that the oxygen storage amount of the three-way catalyst is greater than or equal to the first threshold.

3. The control device according to claim 2, wherein the predetermined period is a period from when the fuel-cut condition is satisfied until the oxygen storage amount of the three-way catalyst becomes greater than or equal to the first threshold.

4. The control device according to claim 1, wherein
determining whether the amount of oxygen stored in the predetermined region is smaller than the predetermined amount includes
determining whether an oxygen storage amount of the three-way catalyst is smaller than a second threshold, in response to the engine air-fuel ratio immediately before satisfaction of the fuel-cut condition being set to a lean air-fuel ratio,
determining that the amount of oxygen stored in the predetermined region is smaller than the predetermined amount, in response to a determination that the oxygen storage amount of the three-way catalyst is smaller than the second threshold, and
determining that the amount of oxygen stored in the predetermined region is greater than or equal to the predetermined amount, in response to a determination that the oxygen storage amount of the three-way catalyst is greater than or equal to the second threshold.

5. The control device according to claim 4, wherein the predetermined period is a period from when the fuel-cut condition is satisfied until the oxygen storage amount of the three-way catalyst becomes greater than or equal to the second threshold.
